(19) United States
(12) Patent Application Publication
(10) Pub. No.: US 2009/0029225 A1
(43) Pub. Date: Jan. 29, 2009

(54) Fuel cell system

(75) Inventors: Cheng-Kuang Teng, Hsinchu (TW); Wei-Jen Cheng, Hsinchu (TW)

Correspondence Address: DAVIDSON BERQUIST JACKSON & GOWDEY LLP, 4300 WILSON BLVD., 7TH FLOOR, ARLINGTON, VA, 22203, US

(73) Assignee: CORETRONIC CORPORATION, Hsinchu (TW)

(21) Appl. No.: 12/010,368

(22) Filed: Jan. 24, 2008

(30) Foreign Application Priority Data
Jul. 23, 2007 (TW) 096126776

(51) Int. Cl. H01M 8/02

(52) U.S. Cl. 429/34

(57) ABSTRACT

A fuel cell system is adapted for use with at least one electrical power source. The fuel cell system includes: a fuel cell body for receiving a fuel, and for generating electrical power; a fuel supply unit adapted to be coupled electrically to the electrical power source, coupled to and in fluid communication with the fuel cell body, and having the fuel stored therein; and a manual driving unit coupled to the fuel supply unit, and operable to permit transfer of the fuel stored in the fuel supply unit to the fuel cell body when electrical power of the electrical power source is insufficient to drive the fuel supply unit for transferring the fuel to the fuel cell body.

### CROSS-REFERENCE TO RELATED APPLICATION

This application claims priority of Taiwanese Application No. 096126776, filed on Jul. 23, 2007.

### BACKGROUND OF THE INVENTION

1. Field of the Invention

The invention relates to a battery system, more particularly to a fuel cell system.

2. Description of the Related Art

As shown in FIG. 1, a conventional fuel cell system 11, such as a direct methanol fuel cell (DMFC) system, includes a fuel supply module 111 and a fuel cell module 112. The fuel supply module 111 uses a pump (not shown) to supply a fuel stored therein into the fuel cell module 112, which generates electrical power from the fuel.

A conventional electronic device (not shown), such as a notebook computer, includes three electrical power sources 10, namely the abovedescribed conventional fuel cell system 11, a lithium battery unit 12, and an alternating-current/direct-current (AC/DC) converting unit 13. The AC/DC converting unit 13 is used for converting commercial AC power into DC electrical power required by the conventional electronic device.

The conventional electronic device further includes a power management system 14, which is coupled electrically between the electrical power sources 10 and a system electrical load 15 produced by various components in the conventional electronic device. The power management system 14 controls supply of electrical power by the three power sources 10 to the system electrical load 15. In order to activate the fuel cell module 112, electrical power provided by the lithium battery unit 12 or obtained through the AC/DC converting unit 13 is required for driving the fuel supply module 111 to supply fuel to the fuel cell module 112 for enabling the fuel cell module 112 to generate electrical power.

However, when the lithium battery unit 12 runs out of power, and no commercial AC power is available, the fuel cell module 112 is unable to generate electrical power even if there is still fuel stored in the fuel supply module 111.

Therefore, a solution is required for fuel cell systems in electronic devices, such as cell phones, notebook computers, etc., to operate when electrical power in the electronic devices is not sufficient for driving the fuel cell systems.

### SUMMARY OF THE INVENTION

Therefore, the present invention is to provide a fuel cell system that can overcome the aforesaid drawbacks of the prior art.

According to the present invention, there is provided a fuel cell system adapted for use with at least one electrical power source. The fuel cell system includes a fuel cell body, a fuel supply unit, and a manual driving unit. The fuel cell body receives a fuel, and generates electrical power. The fuel supply unit is adapted to be coupled electrically to the electrical power source, is coupled to and is in fluid communication with the fuel cell body, and has the fuel stored therein. The manual driving unit is coupled to the fuel supply unit, and is operable to permit transfer of the fuel stored in the fuel supply unit to the fuel cell body when electrical power of the electrical power source is insufficient to drive the fuel supply unit for transferring the fuel to the fuel cell body.

Other objectives, features and advantages of the present invention will be further understood from the further technological features disclosed by the embodiments of the present invention, wherein there are shown and described preferred embodiments of this invention, simply by way of illustration of modes best suited to carry out the invention.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic block diagram of a conventional electronic device incorporating a conventional fuel cell system;

FIG. 2 is a schematic block diagram of an electronic device incorporating a first preferred embodiment of a fuel cell system according to the present invention;

FIG. 3 is a schematic diagram, illustrating a manual driving module of the first preferred embodiment;

FIG. 4 is a schematic diagram, illustrating the manual driving module according to a first implementation of the first preferred embodiment;

FIG. 5 is a schematic diagram, illustrating the manual driving module according to a second implementation of the first preferred embodiment;

FIG. 6 is a schematic diagram, illustrating the manual driving module according to a third implementation of the first preferred embodiment;

FIG. 7 is a flow chart of an electrical power generating method of the electronic device incorporating the first preferred embodiment;

FIG. 8 is a schematic block diagram of an electronic device incorporating a second preferred embodiment of a fuel cell system according to the present invention;

FIG. 9 is a schematic diagram, illustrating a manual driving module of the second preferred embodiment;

FIG. 10 is a schematic diagram, illustrating the manual driving module according to a first implementation of the second preferred embodiment;

FIG. 11 is a schematic diagram, illustrating the manual driving module according to a second implementation of the second preferred embodiment;

FIG. 12 is a schematic diagram, illustrating the manual driving module according to a third implementation of the second preferred embodiment;

FIG. 13 is a schematic diagram of the manual driving module of FIG. 12;

FIG. 14 is a flow chart of an electrical power generating method of the electronic device incorporating the second preferred embodiment;

FIG. 15 is a schematic block diagram of an electronic device incorporating a third preferred embodiment of a fuel cell system according to the present invention;

FIG. 16 is a schematic diagram, illustrating a manual driving module of the third preferred embodiment;

FIG. 17 is a schematic diagram, illustrating the manual driving module according to a first implementation of the third preferred embodiment;

FIG. 18 is a schematic diagram, illustrating the manual driving module according to a second implementation of the third preferred embodiment;

FIG. 19 is a schematic diagram, illustrating the manual driving module according to a third implementation of the third preferred embodiment; and

FIG. 20 is a flow chart of an electrical power generating method of the electronic device incorporating the third preferred embodiment.

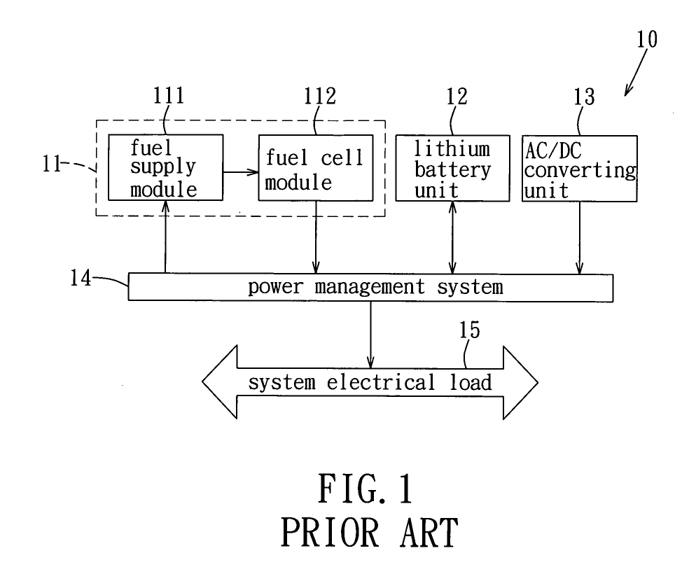

### DETAILED DESCRIPTION OF THE PREFERRED EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein are meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component faces “B” component directly or one or more additional components is between “A” component and “B” component. Also, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

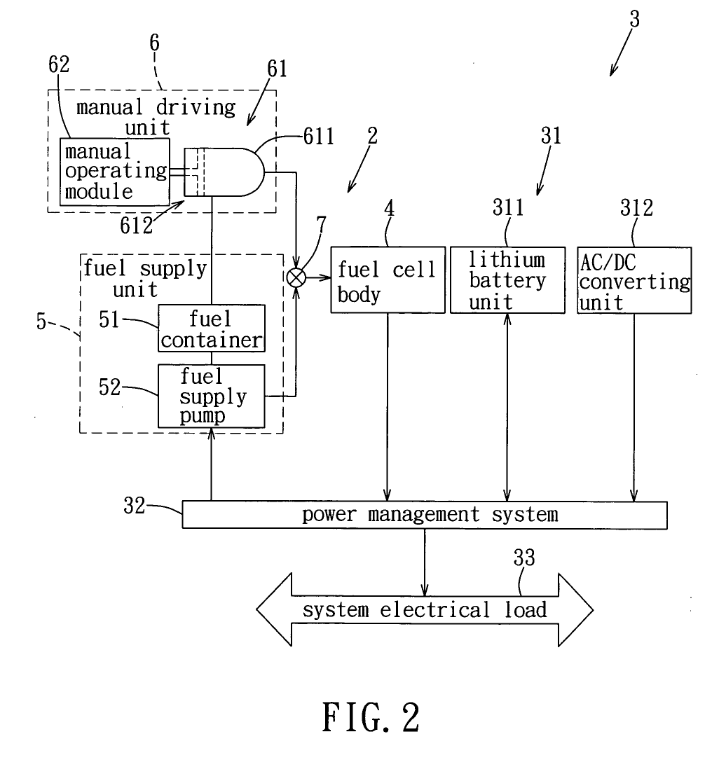

Referring to FIG. 2, the first preferred embodiment of a fuel cell system 2 according to the present invention can be implemented in an electronic device 3, which is preferably a portable electronic device such as a notebook computer or a mobile phone. In order to ensure continuous operation, the electronic device 3 includes at least one electrical power source 31 in addition to the fuel cell system 2, and a power management system 32 that manages the electrical power source 31 and the fuel cell system 2. For illustration purposes, the electronic device 3 includes two of the electrical power sources 31, namely a lithium battery unit 311 and an alternating-current/direct-current (AC/DC) converting unit 312. The AC/DC converting unit 312 is used for converting commercial AC power (not shown) into DC electrical power required by the electronic device 3. The power management system 32 selects one of the electrical power sources 31 and the fuel cell system 2 for providing the electrical power required by a system electrical load 33 generated by other electronic components of the electronic device 3. The power management system 32 further determines whether the electrical power provided by the electrical power sources 31 is sufficient to drive the fuel cell system 2.

According to this embodiment, the fuel cell system 2 includes a fuel cell body 4, a fuel supply unit 5 and a manual driving unit 6.

The fuel cell body 4 receives a fuel (not shown), and generates electrical power. In this embodiment, the fuel cell body 4 is a direct methanol fuel cell (DMFC), and the fuel is a methanol fuel. However, since various types of fuel cell bodies are available, the fuel cell body 4 should not be limited to the DMFC in other embodiments of the present invention. Accordingly, the fuel should not be limited to the methanol fuel in other embodiments of the present invention.

The fuel supply unit 5 is adapted to be coupled electrically to the electrical power sources 31, is coupled to and is in fluid communication with the fuel cell body 4, and has the fuel stored therein. In this embodiment, the fuel supply unit 5 is adapted to be coupled electrically to the electrical power sources 31 via the power management system 32. In this embodiment, the fuel supply unit 5 includes a fuel container 51 for storing the fuel therein, and a fuel supply pump 52 is in fluid communication with the fuel container 51 and the fuel cell body 4. The fuel supply pump 52 may be driven by electrical power to transfer the fuel stored in the fuel container 51 to the fuel cell body 4.

The manual driving unit 6 is coupled to the fuel supply unit 5, and is operable to permit transfer of the fuel stored in the fuel supply unit 5 to the fuel cell body 4 when electrical power of the electrical power sources 31 is insufficient to drive the fuel supply unit 5 for transferring the fuel to the fuel cell body 4.

In this embodiment, the fuel cell system 2 further includes a switching unit 7 that is coupled to the fuel cell body 4, the fuel supply unit 5 and the manual driving unit 6, and that is operable to select whether transfer of the fuel in the fuel supply unit 5 to the fuel cell body 4 should involve the manual driving unit 6. Therefore, the manual driving unit 6 is optionally operable to permit transfer of the fuel stored in the fuel supply unit 5 to the fuel cell body 4.

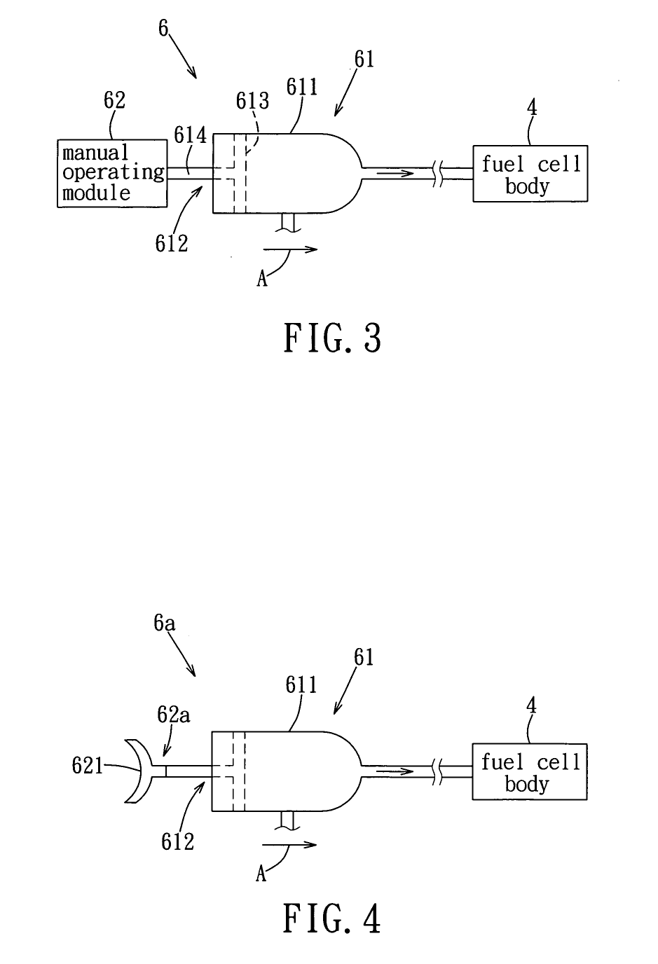

According to the first preferred embodiment, the switching unit 7 is operable to select whether the fuel in the fuel supply unit 5 is transferred directly to the fuel cell body 4 or indirectly through the manual driving unit 6. The switching unit 7 is a switching valve operable to switch source of fluid or gas. As shown in FIG. 3, the manual driving unit 6 includes a manual pump 61 and a manual operating module 62. The manual pump 61 is coupled to and is in fluid communication with the fuel supply unit 5, and is disposed in fluid communication with the fuel cell body 4 when the switching unit 7 is operated to select indirect transfer of the fuel. The manual operating module 62 is coupled to the manual pump 61 for driving operation of the manual pump 61 so as to draw the fuel from the fuel supply unit 5. More specifically, the manual pump 61 includes a fuel cylinder 611 and a fuel delivering component 612. The fuel cylinder 611 is disposed in fluid communication with the fuel supply unit 5, and is disposed in fluid communication with the fuel cell body 4 when the switching unit 7 is operated to select indirect transfer of the fuel. The fuel delivering component 612 is partially disposed in the fuel cylinder 611 for transferring the fuel to the fuel cell body 5. In particular, the fuel delivering component 612 includes a piston head 613 disposed in the fuel cylinder 611, and a piston rod 614 coupled to the piston head 613 and extending out of the fuel cylinder 611.

When the switching unit 7 is operated to select indirect transfer of the fuel, where the fuel in the fuel supply unit 5 is transferred indirectly to the fuel cell body 4 through the manual driving unit 6, the manual operating module 62 of the manual driving unit 6 is operated to mechanically generate a force for driving movement of the fuel delivering component 612 of the manual pump 61 so as to draw and deliver the fuel from the fuel supply unit 5 to the fuel cell body 4 in a fuel delivering direction (A), such that the fuel cell body 4 can generate electrical power required by the system electrical load 33.

The manual operating module 62 can take various forms, three of which are presented hereinbelow for illustration.

Referring to FIG. 4, according to a first implementation of the first preferred embodiment, the manual operating module 62a is a push rod that is coupled to the fuel delivering component 612 of the manual pump 61, and that is operable to move the fuel delivering component 612 such that the fuel delivering component 612 transfers the fuel to the fuel cell body 4. In this implementation, the push rod has a handle portion 621, which can be grasped by a user for operating the push rod in the fuel delivering direction (A).

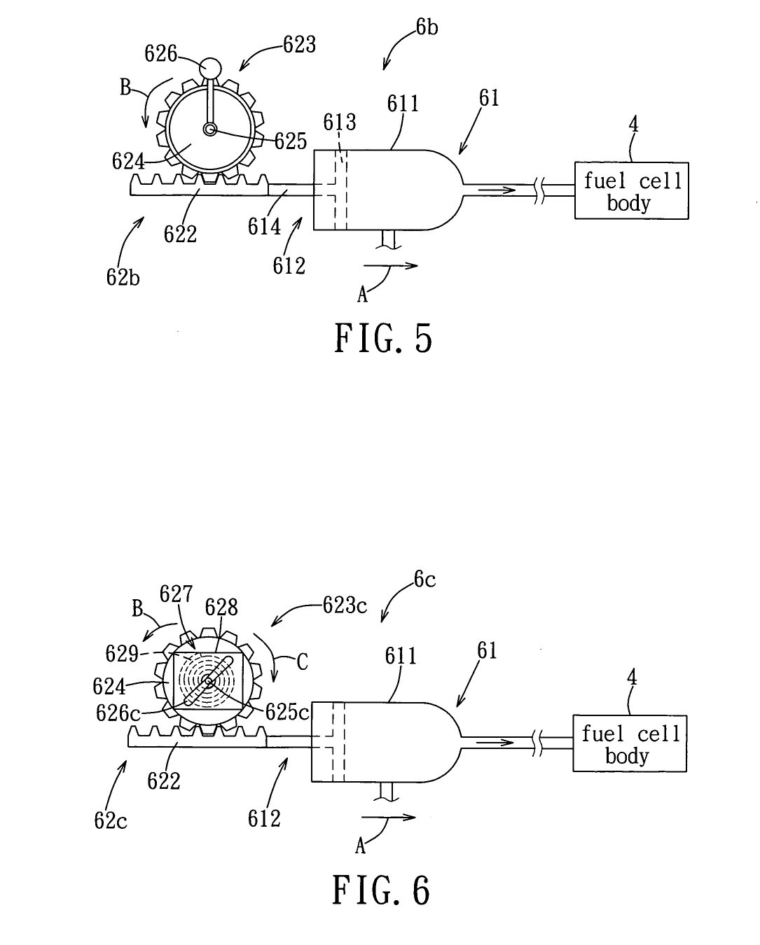

Referring to FIG. 5, according to a second implementation of the first preferred embodiment, the manual operating module 62b includes a rack (also referred to as a linear gear) 622 that is coupled to the fuel delivering component 612 of the manual pump 61, and a rotary component 623 that meshes with the rack 622 for driving the rack 622 to move the fuel delivering component 612 so as to deliver the fuel to the fuel cell body 4. In this implementation, the rotary component 623 includes a gear wheel 624 that meshes with the rack 622, a crankshaft 625 that is coupled to the gear wheel 624, and that extends along a rotation axis of the gear wheel 624, and a crank 626 that is coupled to the crankshaft 625, and that is operable to rotate the crankshaft 625 for driving rotation of the gear wheel 624 about the rotation axis in a rotation direction (B).

Referring to FIG. 6, a third implementation of the first preferred embodiment differs from the second implementation in the rotary component 623c of the manual operating module 62c. The rotary component 623c of the third implementation includes the gear wheel 624, a drive shaft 625c, and a spring mechanism 627. The gear wheel 624 meshes with the rack 622. The drive shaft 625c is coupled to the gear wheel 624, and extends along the rotation axis of the gear wheel 624. The spring mechanism 637 is coupled to the drive shaft 625c, and is operable to rotate the drive shaft 625c for driving rotation of the gear wheel 624 about the rotation axis along the rotation direction (B). In this implementation, the spring mechanism 627 includes a box body 628, a rotating arm 626c that extends out of the box body 628, and that is coupled to the drive shaft 625c, and a spiral spring 629 that has two ends respectively coupled to the box body 628 and the rotating arm 626c. The rotating arm 626c is operated in a spring operating direction (C) such that an elastic restoring force is stored in the spiral spring 629. Once the rotating arm 626c is released, the spiral spring 629 rotates the drive shaft 625c in the rotation direction (B) opposite to the spring operating direction (C) by virtue of the elastic restoring force, thereby driving rotation of the gear wheel 624 about the rotation axis in the rotation direction (B), which moves the rack 622 and the fuel delivering component 612 in the fuel delivering direction (A) for transferring the fuel to the fuel cell body 4. It should be noted herein that the particular configuration of the spring mechanism 627 as disclosed herein for the third implementation is merely illustrative, and practical implementations of the same in other embodiments of the present invention should not be limited thereto. In other words, any spring mechanism that is capable of achieving the required objects and functions should be covered by the scope of the present invention.

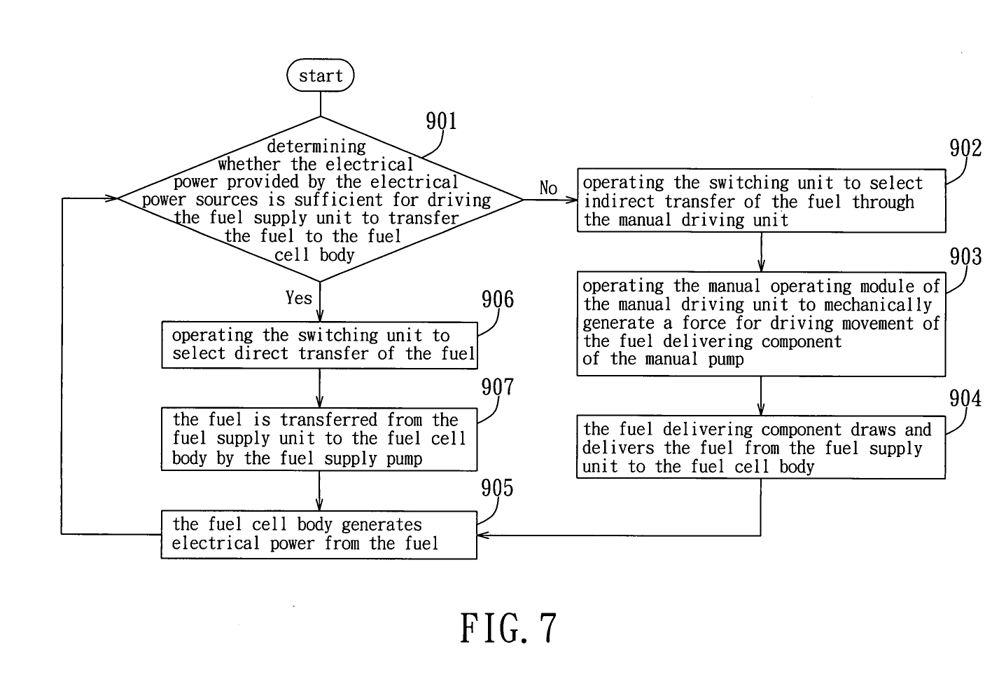

Referring to FIG. 2, FIG. 3 and FIG. 7, according to the first preferred embodiment, an electrical power generating method for the electronic device 3 incorporating the fuel cell system 2 includes the following steps:

First, in step 901, the power management system 32 determines whether the electrical power provided by the electrical power sources 31 is sufficient for driving the fuel supply unit 5 of the fuel cell system 2 to transfer the fuel stored in the fuel container 51 of the fuel supply unit 5 to the fuel cell body 4. The power management system 32 can detect whether the electrical power provided by the electrical power sources 31 is below a nominal voltage level, in which case, the electrical power is deemed insufficient. In the negative, the flow goes to step 902, where the switching unit 7 is operated to select indirect transfer of the fuel through the manual driving unit 6.

Subsequently, in step 903, the manual operating module 62 of the manual driving unit 6 is operated to mechanically generate a force for driving movement of the fuel delivering component 612 of the manual pump 61 in the fuel delivering direction (A). The manual operating module 62 can be implemented in any of the abovedescribed manners.

As a result of the movement of the fuel delivering component 612, in step 904, the fuel delivering component 612 draws and delivers the fuel from the fuel supply unit 5 to the fuel cell body 4, such that the fuel cell body 4 can generate electrical power from the fuel (step 905).

Next, the flow goes back to step 901. If the power management system 32 determines that the electrical power provided by the electrical power sources 31 is sufficient for driving the fuel supply pump 52 of the fuel supply unit 5, the flow goes to step 906. In step 906, the switching unit 7 is operated to select direct transfer of the fuel. In step 907, the fuel is transferred from the fuel supply unit 5 to the fuel cell body 4 by the fuel supply pump 52.

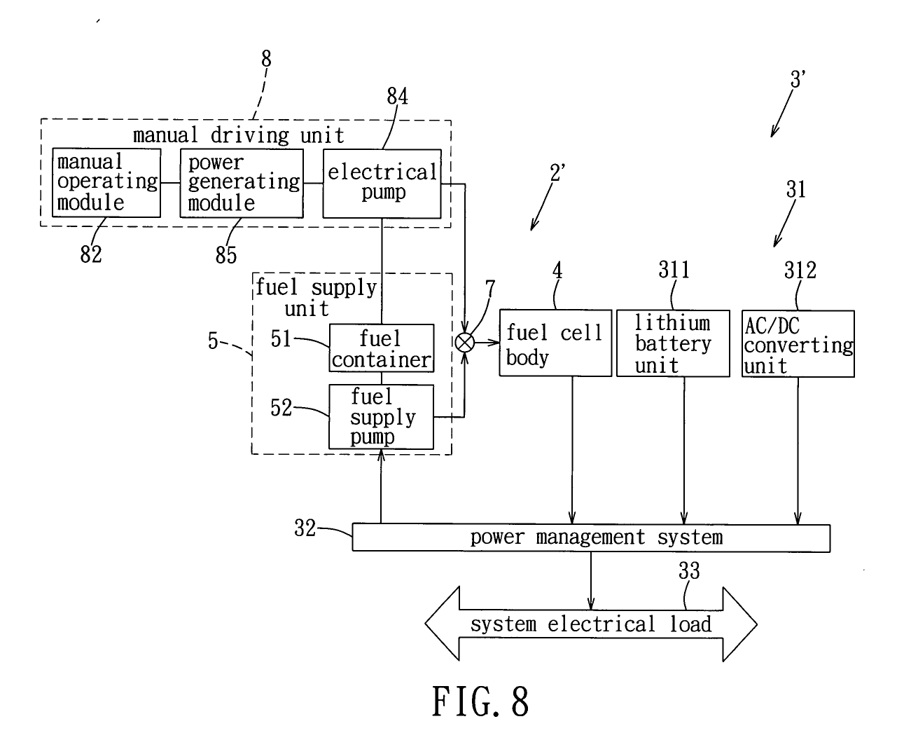

As shown in FIG. 8, the second preferred embodiment of the fuel cell system 2′ according to the present invention differs from the first preferred embodiment in the manual driving unit 8. The manual driving unit 8 of the second preferred embodiment is optionally operable to generate electrical power when the fuel from the fuel supply unit 5 is to be transferred thereby to the fuel cell unit 4.

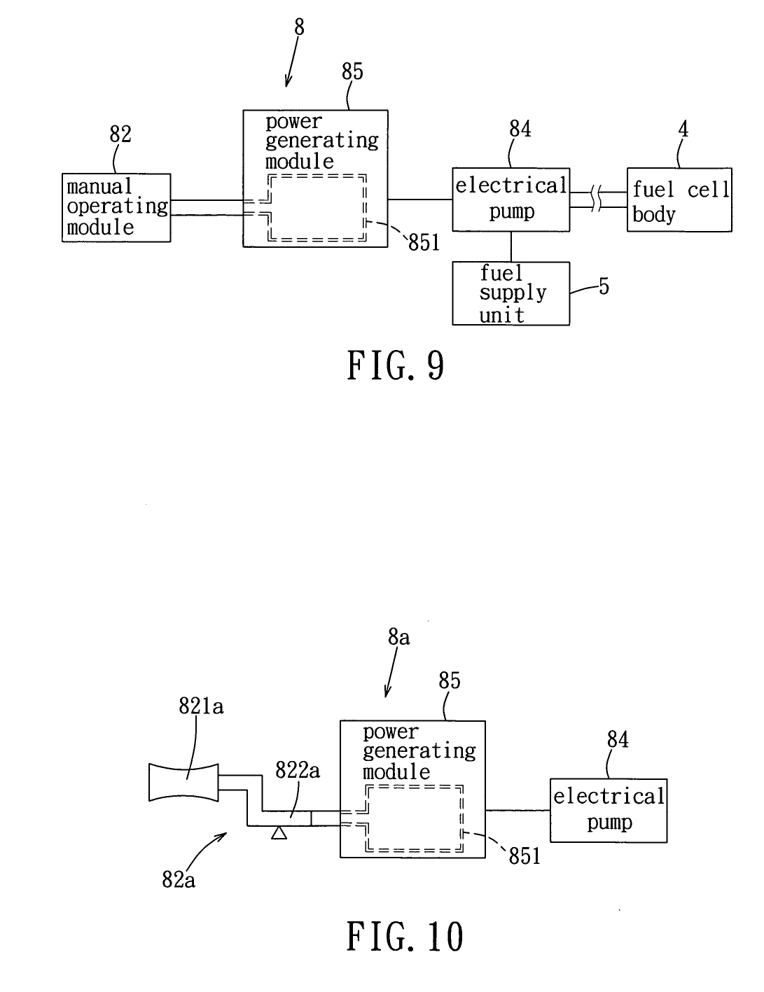

As shown in FIG. 8 and FIG. 9, the manual driving unit 8 includes an electrical pump 84, a power generating module 85, and a manual operating module 82. The electrical pump 84 is coupled to and is disposed in fluid communication with the fuel supply unit 5, and is disposed in fluid communication with the fuel cell body 4 when the switching unit 7 is operated to select indirect transfer of the fuel. The power generating module 85 is coupled electrically to the electrical pump 84 for driving the electrical pump 84, and includes a rotor component 851. The manual operating module 82 is coupled to the rotor component 851 of the power generating module 85. When the electrical power provided by the electrical power sources 31 is insufficient for driving the fuel supply unit 5 to transfer the fuel to the fuel cell body 4, the manual operating module 82 is operable to generate a mechanical force for driving rotation of the rotor component 851 of the power generating module 85. The rotation of the rotor component 851 generates an electromotive force that results in an electrical power for driving the electrical pump 84 to draw and deliver the fuel from the fuel container 51 of the fuel supply unit 5 to the fuel cell body 4.

The manual operating module 82 can take various forms, three of which are presented hereinbelow for illustration.

As shown in FIG. 10, according to a first implementation of the second preferred embodiment, the manual operating module 82a includes an operating component 821a, and a drive shaft 822a that is coupled between the rotor component 851 of the power generating module 85 and the operating component 821a. The operating component 821a is operable to drive rotation of the drive shaft 822a so as to result in rotation of the rotor component 851. In this implementation, the operating component 821a is a crank that extends from the drive shaft 822a away from the rotor component 851, and that is bent at an angle. The operating component 821a is held by the user to rotate about a rotation axis of the drive shaft 822a, which drives rotation of the drive shaft 822a and the rotor component 851. Consequently, the power generating module 85 generates electrical power due to the rotation of the rotor component 851, thereby driving the electrical pump 84 for drawing and delivering the fuel from the fuel container 51 (shown in FIG. 8) of the fuel supply unit 5 to the fuel cell body 4.

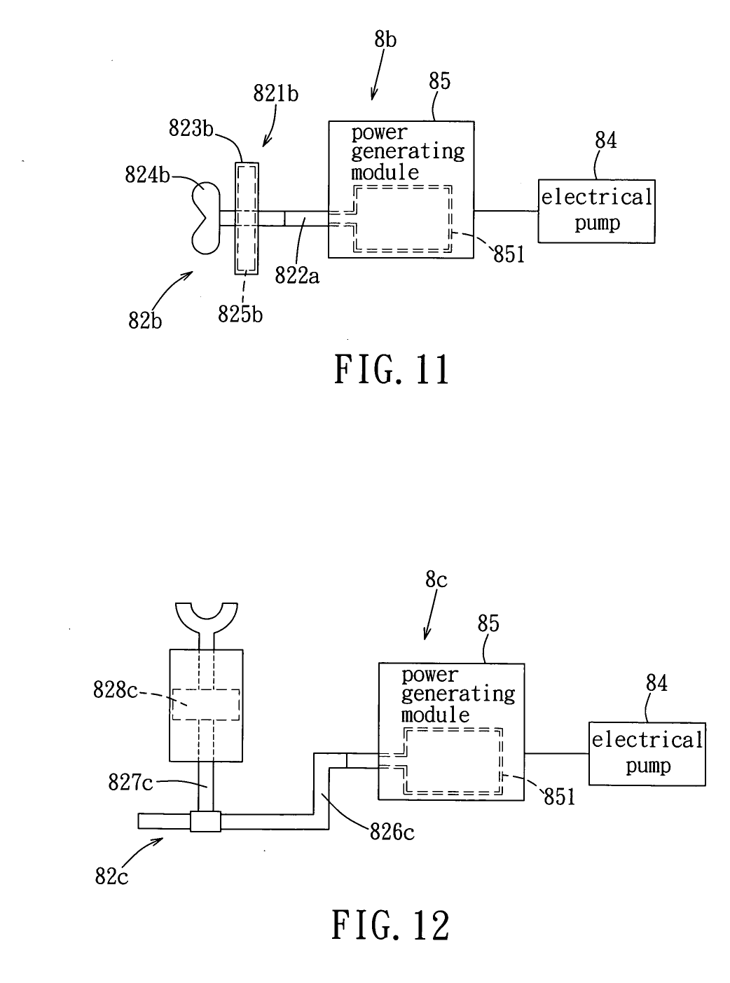

As shown in FIG. 11, a second implementation of the second preferred embodiment differs from the first implementation shown in FIG. 10 in that the operating component 821b of the second implementation is a spring mechanism. The spring mechanism is similar to the spring mechanism 627 shown in FIG. 6. More particularly, the spring mechanism includes a box body 823b, a rotating arm 824b that extends out of the box body 823b, and that is coupled to the drive shaft 822a, and a spiral spring 825b that has two ends respectively coupled to the box body 823b and the rotating arm 824b. The rotating arm 824b is rotated in a spring operating direction such that an elastic restoring force is stored in the spiral spring 825b. Once the rotating arm 824b is released, the spiral spring 825b rotates the drive shaft 822a in a rotation direction opposite to the spring operating direction by virtue of the elastic restoring force, thereby driving rotation of the rotor component 851 of the power generating module 85. Consequently, electrical power is generated by the power generating module 85 for driving the electrical pump 84.

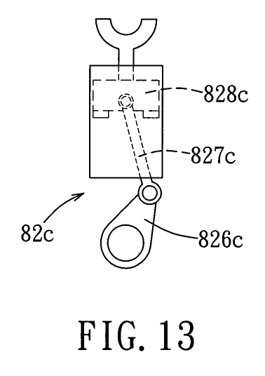

As shown in FIG. 12 and FIG. 13, according to a third implementation of the second preferred embodiment, the manual operating module 82c includes a crank 826c coupled to the rotor component 851 of the power generating module 85, a push-pull piston 828c, and a connecting rod 827c coupled between the crank 826c and the push-pull piston 828c. The push-pull piston 828c is operable by a reciprocating push-pull movement to move the connecting rod 827c for rotating the crank 826c so as to result in rotation of the rotor component 851. This principle is similar to that of a piston movement in an internal combustion engine. As a result of the rotation of the rotor component 851, electrical power is generated by the power generating module 85 for driving the electrical pump 84.

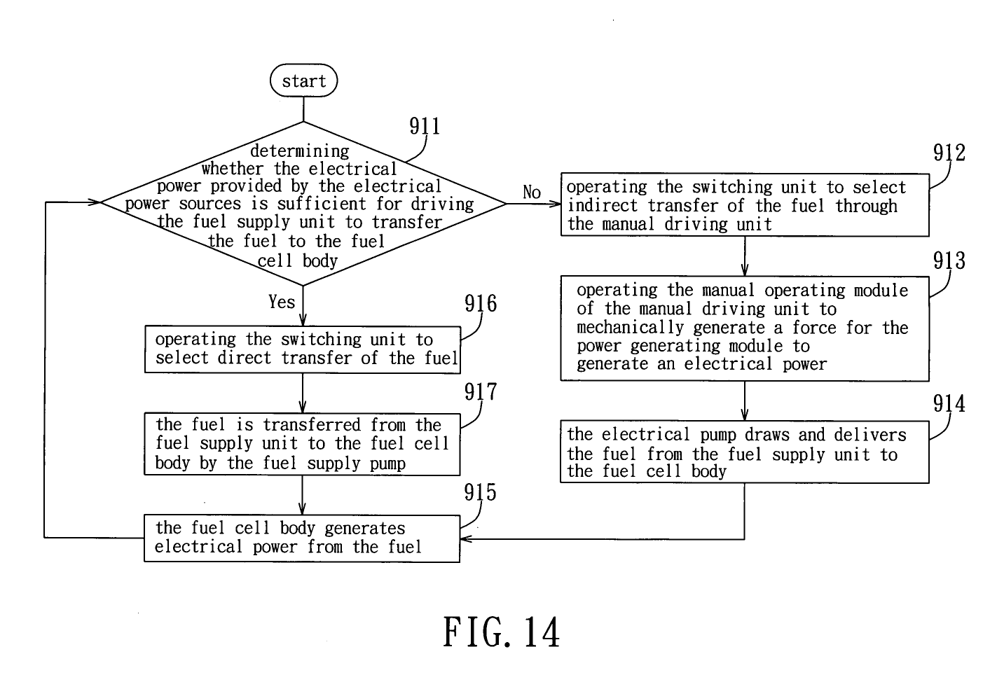

Referring now to FIG. 8, FIG. 9 and FIG. 14, according to the second preferred embodiment, an electrical power generating method for the electronic device 3′ incorporating the fuel cell system 2′ includes the following steps:

First, in step 911, the power management system 32 determines whether the electrical power provided by the electrical power sources 31 is sufficient for driving the fuel supply unit 5 of the fuel cell system 2′ to transfer the fuel stored in the fuel container 51 of the fuel supply unit 5 to the fuel cell body 4. The power management system 32 can detect whether the electrical power provided by the electrical power sources 31 is below a nominal voltage level, in which case, the electrical power is deemed insufficient. In the negative, the flow goes to step 912, where the switching unit 7 is operated to select indirect transfer of the fuel through the manual driving unit 8.

Subsequently, in step 913, the manual operating module 82 of the manual driving unit 8 is operated to mechanically generate a force for driving rotation of the rotor component 851 of the power generating module 85, which generates an electromotive force that results in an electrical power for driving the electrical pump 84.

As a result of the movement of the rotor component 851, in step 914, the electrical pump 84 draws and delivers the fuel from the fuel container 51 of the fuel supply unit 5 to the fuel cell body 4, such that the fuel cell body 4 can generate electrical power (step 915).

Next, the flow goes back to step 911. If the power management system 32 determines that the electrical power provided by the electrical power sources 31 is sufficient for driving the fuel supply pump 52 of the fuel supply unit 5, the flow goes to step 916. In step 916, the switching unit 7 is operated to select direct transfer of the fuel. In step 917, the fuel is transferred from the fuel supply unit 5 to the fuel cell body 4 by the fuel supply pump 52, such that the fuel cell body 4 can generate electrical power.

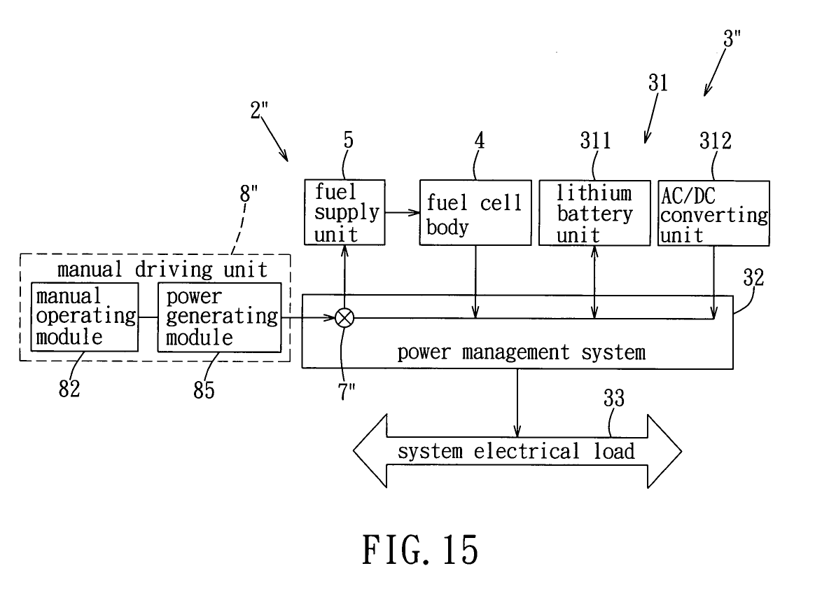

As shown in FIG. 15, the third preferred embodiment of a fuel cell system 2″ according to the present invention differs from the second preferred embodiment in that the manual driving unit 8″ does not include the electrical pump 84 of the second preferred embodiment. Moreover, the switching unit 7″ of the third preferred embodiment is further coupled to the electrical power sources 31, and is operable to select which one of the manual driving unit 8″, the electrical power sources 31, and the fuel cell body 4 supplies electrical power to drive the fuel supply unit 5 for transferring the fuel to the fuel cell body 4. In this embodiment, the switching unit 7″ can be a metal-oxide-semiconductor field effect transistor (MOSFET), a Relay, or a single switch, and can be incorporated into the power management system 32 for enhancing the performance efficiency of the electronic device 3″.

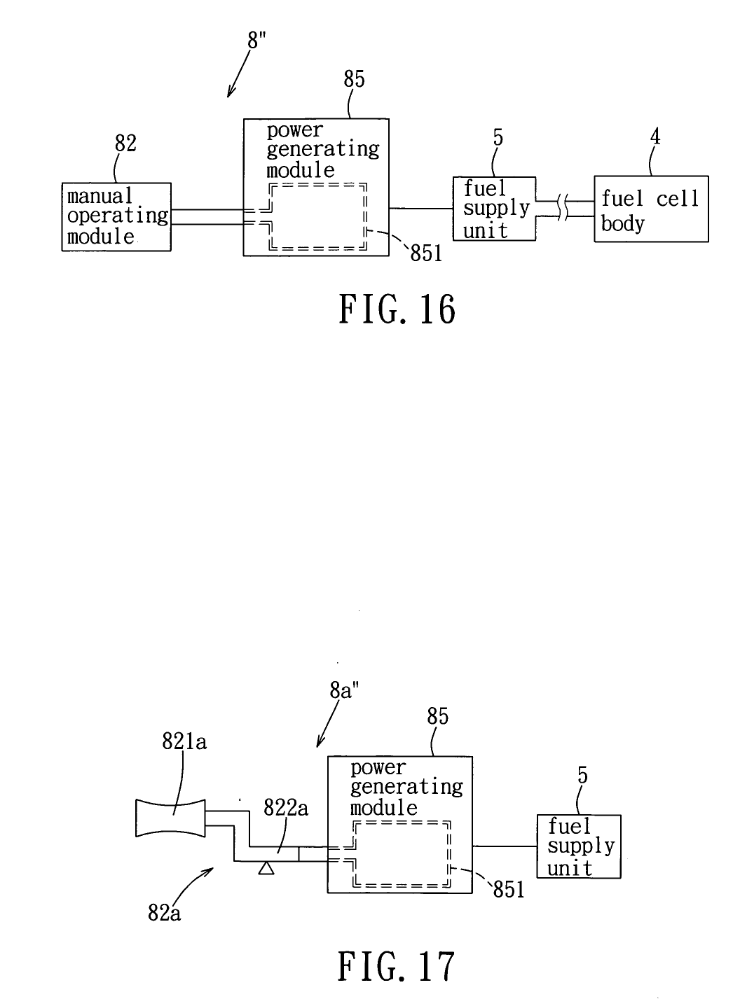

As shown in FIG. 16, similar to the second preferred embodiment, the manual driving unit 8″ is capable of generating electrical power. However, the electrical power generated by the manual driving unit 8″ is not used for driving an electrical pump 84 as the second preferred embodiment, but is used instead for driving the fuel delivering pump 52 (refer to FIG. 8) of the fuel supply unit 5. In this embodiment, the manual driving unit 8″ includes a power generating module 85 and a manual operating module 82. The power generating module 85 includes a rotor component 851, and is coupled to the fuel supply unit 5 when the switching unit 7″ is operated to select the manual driving unit 8″ to supply the electrical power to the fuel supply unit 5. The manual operating module 82 is coupled to the rotor component 851.

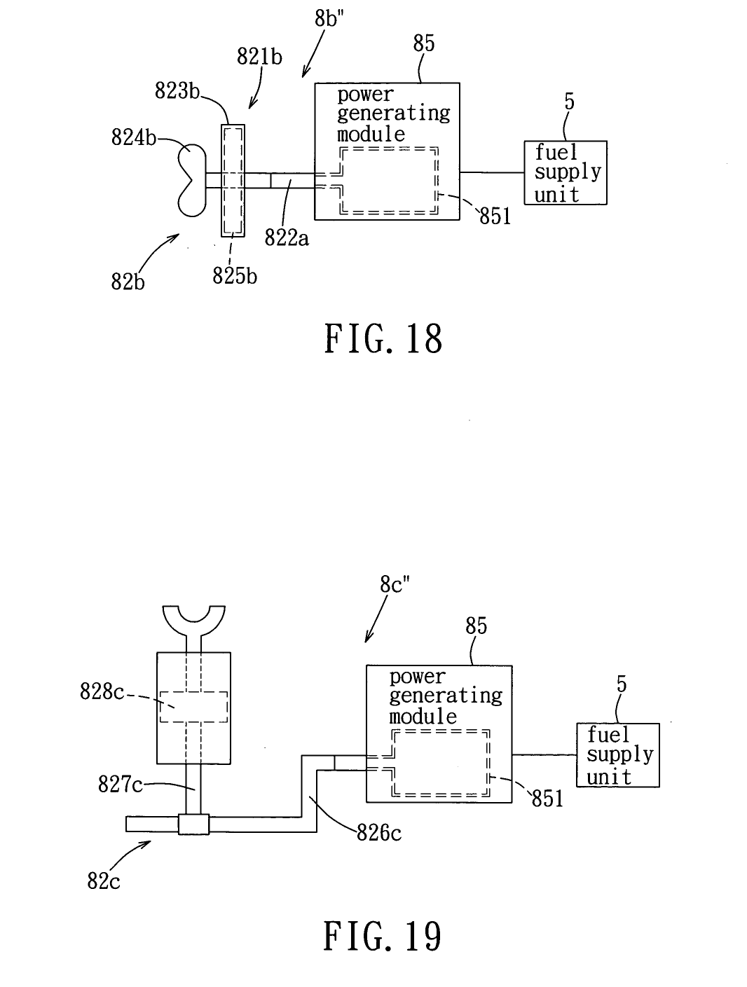

As shown in FIG. 16 and FIG. 17, according to the first implementation of the third preferred embodiment, the manual operating module 82a includes an operating component 821a, and a drive shaft 822a that is coupled between the rotor component 851 and the operating component 821a. The operating component 821a is operable to drive rotation of the drive shaft 822a so as to result in rotation of the rotor component 851. In this implementation, the operating component 821a is a crank. In a second implementation of the third preferred embodiment shown in FIG. 18, the operating component 821b is a spring mechanism. Since operations of the manual operating modules 82a, 82b are identical to those of the first and second implementations of the second preferred embodiment shown in FIG. 10 and FIG. 11, further details of the same are omitted herein for the sake of brevity. It should be noted herein that, different from the first and second implementations of the second preferred embodiment, the electrical power generated by the power generating module 85 is provided to the fuel supply unit 5 for driving the fuel supply pump 52 (shown in FIG. 2) to transfer the fuel stored in the fuel container 51 to the fuel cell body 4.

As shown in FIG. 19, according to a third implementation of the third preferred embodiment, the manual operating module 82c includes a crank 826c coupled to the rotor component 851 of the power generating module 85, a push-pull piston 828c, and a connecting rod 827c coupled between the crank 826c and the push-pull piston 828c. The push-pull piston 828c is operable to move the connecting rod 827c for rotating the crank 826c so as to result in rotation of the rotor component 851. Reference can be made to the third implementation of the second preferred embodiment shown in FIG. 12 and FIG. 13 for further details of the operation of the manual operating module 82c. It should be noted herein that, different from the third implementation of the second preferred embodiment, the electrical power generated by the power generating module 85 is provided to the fuel supply unit 5 for driving the fuel supply pump 52 (shown in FIG. 2) to transfer the fuel stored in the fuel container 51 to the fuel cell body 4.

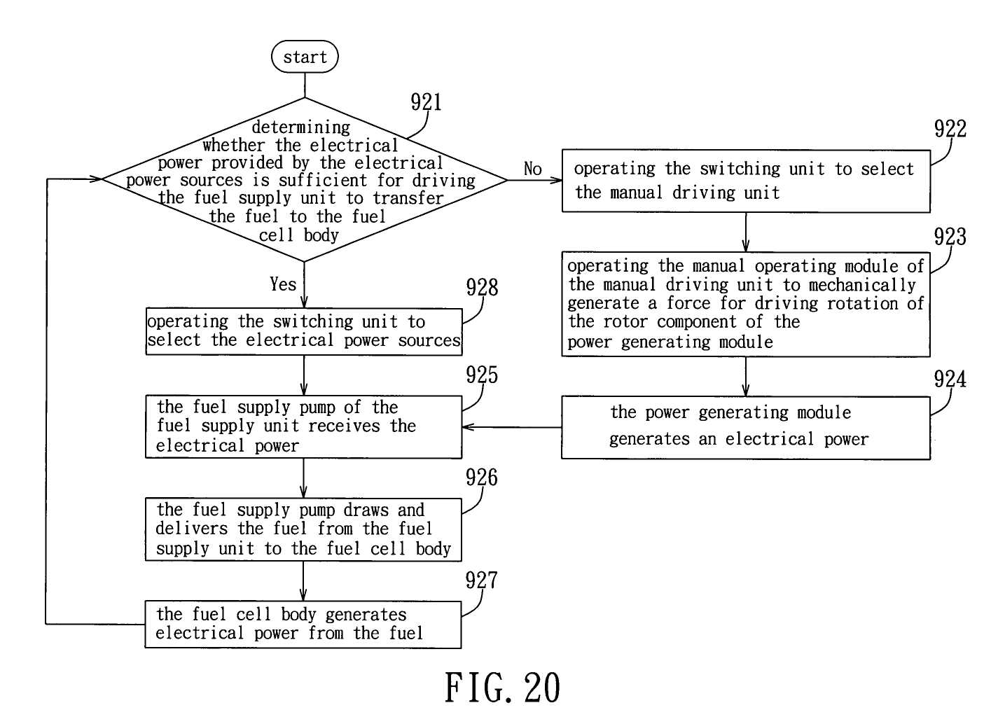

As shown in FIG. 15, FIG. 16 and FIG. 20, according to the third preferred embodiment, an electrical power generating method for the electronic device 3″ incorporating the fuel cell system 2″ includes the following steps:

First, in step 921, the power management system 32 determines whether the electrical power provided by the electrical power sources 31 is sufficient for driving the fuel supply unit 5 of the fuel cell system 2″ to transfer the fuel stored in the fuel container 51 thereof to the fuel cell body 4. In the negative, the flow goes to step 922, where the switching unit 7″ is operated to select the manual driving unit 8″ to supply the electrical power to the fuel supply unit 5.

Subsequently, in step 923, the manual operating module 82 of the manual driving unit 8″ is operated to mechanically generate a force for driving rotation of the rotor component 851 of the power generating module 85.

Next, in step 924, the power generating module 85 generates an electrical power as a result of the rotation of the rotor component 851 and provides the electrical power to the fuel supply unit 5. As the fuel supply pump 52 of the fuel supply unit 5 (refer to FIG.8) receives the electrical power (step 925), the fuel supply pump 52 draws and delivers the fuel from the fuel container 51 to the fuel cell body 4 (step 926). Consequently, in step 927, the fuel cell body 4 generates electrical power from the fuel.

Next, the flow goes back to step 921. If the power management system 32 determines that the electrical power provided by the electrical power sources 31 is sufficient for driving the fuel supply pump 52 of the fuel supply unit 5, the flow goes to step 928. In step 928, the switching unit 7″ is operated to select the electrical power sources 31 to provide the electrical power required by the fuel supply unit 5. Then, the flow goes to steps 925, 926 and 927, such that the fuel cell body 4 generates electrical power from the fuel.

In sum, the first, second and third preferred embodiments of the fuel cell system 2, 2′, 2″ described in the foregoing are common in that the manual driving unit 6, 8, 8″ is provided to permit transfer of the fuel stored in the fuel supply unit 5 to the fuel cell body 4 by providing a driving force when electrical power of the electrical power sources 31 is insufficient to drive the fuel supply unit 5 for transferring the fuel to the fuel cell body 4. In the first and second preferred embodiments, the manual driving unit 6, 8 is provided as a supplementary component for transferring the fuel in the fuel supply unit 5 indirectly therethrough to the fuel cell body 4. In the third preferred embodiment, the manual driving unit 8″ is provided as a supplementary electrical power source for providing electrical power to the fuel supply unit 5 such that the fuel supply unit 5 is able to transfer the fuel stored therein to the fuel cell body 4. For all of the first, second and third preferred embodiments, once sufficient electrical power is generated by the fuel cell body 4, transfer of the fuel stored in the fuel supply unit 5 no longer requires the involvement of the manual driving unit 6, 8, 8″. The electrical power generated by the fuel cell body 4 can even charge up the rest of the electrical power sources 31, such as the lithium battery unit 311, in the electronic device 3, 3′, 3″. The advantage of the present invention resides in that the mobility of the electronic device 3, 3′, 3″ incorporating the fuel cell system 2, 2′, 2″ is enhanced, i.e., the electronic device 3, 3′, 3″ can operate anywhere regardless of the presence of commercial AC power sources or the like.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like do not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A fuel cell system adapted for use with at least one electrical power source, said fuel cell system comprising:
a fuel cell body for receiving a fuel, and for generating electrical power;
a fuel supply unit adapted to be coupled electrically to the electrical power source, coupled to and in fluid communication with said fuel cell body, and having the fuel stored therein; and
a manual driving unit coupled to said fuel supply unit, and operable to permit transfer of the fuel stored in said fuel supply unit to said fuel cell body when electrical power of the electrical power source is insufficient to drive said fuel supply unit for transferring the fuel to said fuel cell body.

2. The fuel cell system as claimed in claim 1, further comprising a switching unit coupled to said fuel cell body, said fuel supply unit and said manual driving unit, and operable to select whether transfer of the fuel in said fuel supply unit to said fuel cell body should involve said manual driving unit.

3. The fuel cell system as claimed in claim 2, wherein said switching unit is operable to select whether the fuel in said fuel supply unit is transferred directly to said fuel cell body or indirectly through said manual driving unit.

4. The fuel cell system as claimed in claim 3, wherein said manual driving unit includes a manual pump and a manual operating module, the manual pump being coupled to and in fluid communication with said fuel supply unit, and being disposed in fluid communication with said fuel cell body when said switching unit is operated to select indirect transfer of the fuel, the manual operating module being coupled to said manual pump for driving operation of said manual pump so as to draw the fuel from said fuel supply unit.

5. The fuel cell system as claimed in claim 4, wherein said manual pump includes a fuel cylinder and a fuel delivering component, the fuel cylinder being disposed in fluid communication with said fuel supply unit, and being disposed in fluid communication with said fuel cell body when said switching unit is operated to select indirect transfer of the fuel, the fuel delivering component being partially disposed in said fuel cylinder for transferring the fuel to said fuel cell body.

6. The fuel cell system as claimed in claim 5, wherein said manual operating module is a push rod that is coupled to said fuel delivering component of said manual pump, and that is operable to move said fuel delivering component such that said fuel delivering component transfers the fuel to said fuel cell body.

7. The fuel cell system as claimed in claim 5, wherein said manual operating module includes a rack that is coupled to said fuel delivering component of said manual pump, and a rotary component that meshes with said rack for driving said rack to move said fuel delivering component to deliver the fuel to said fuel cell body.

8. The fuel cell system as claimed in claim 7, wherein said rotary component of said manual operating module includes a gear wheel that meshes with said rack, a crankshaft that is coupled to said gear wheel, and that extends along a rotation axis of said gear wheel, and a crank that is coupled to said crankshaft, and that is operable to rotate said crankshaft for driving rotation of said gear wheel about the rotation axis.

9. The fuel cell system as claimed in claim 7, wherein said rotary component of said manual operating module includes a gear wheel that meshes with said rack, a drive shaft that is coupled to said gear wheel, and that extends along a rotation axis of said gear wheel, and a spring mechanism that is coupled to said drive shaft, and that is operable to rotate said drive shaft for driving rotation of said gear wheel about the rotation axis.

10. The fuel cell system as claimed in claim 3, wherein said manual driving unit includes an electrical pump, a power generating module and a manual operating module, the electrical pump being coupled to and disposed in fluid communication with said fuel supply unit and being disposed in fluid communication with said fuel cell body when said switching unit is operated to select indirect transfer of the fuel, the power generating module being coupled electrically to said electrical pump for driving said electrical pump and including a rotor component, the manual operating module being coupled to said rotor component of said power generating module.

11. The fuel cell system as claimed in claim 10, wherein said manual operating module includes an operating component, and a drive shaft that is coupled between said rotor component and said operating component, said operating component being operable to drive rotation of said drive shaft so as to result in rotation of said rotor component.

12. The fuel cell system as claimed in claim 11, wherein said operating component is a crank.

13. The fuel cell system as claimed in claim 11, wherein said operating component is a spring mechanism.

14. The fuel cell system as claimed in claim 11, wherein said manual operating module includes a crank coupled to said rotor component of said power generating module, a push-pull piston, and a connecting rod coupled between said crank and said push-pull piston, said push-pull piston being operable to move said connecting rod for rotating said crank so as to result in rotation of said rotor component.

15. The fuel cell system as claimed in claim 2, wherein said switching unit is further coupled to the electrical power source, and is operable to select which one of said manual driving unit, the electrical power source, and said fuel cell body supplies electrical power to drive said fuel supply unit for transferring the fuel to said fuel cell body.

16. The fuel cell system as claimed in claim 15, wherein said manual driving unit includes a power generating module and a manual operating module, the power generating module including a rotor component and being coupled to said fuel supply unit when said switching unit is operated to select said manual driving unit to supply the electrical power to said fuel supply unit, the manual operating module being coupled to said rotor component.

17. The fuel cell system as claimed in claim 16, wherein said manual operating module includes an operating component, and a drive shaft that is coupled between said rotor component and said operating component, said operating component being operable to drive rotation of said drive shaft so as to result in rotation of said rotor component.

18. The fuel cell system as claimed in claim 17, wherein said operating component is a crank.

19. The fuel cell system as claimed in claim 17, wherein said operating component is a spring mechanism.

20. The fuel cell system as claimed in claim 16, wherein said manual operating module includes a crank coupled to said rotor component of said power generating module, a push-pull piston, and a connecting rod coupled between said crank and said push-pull piston, said push-pull piston being operable to move said connecting rod for rotating said crank so as to result in rotation of said rotor component.
